(19) United States
(12) Patent Application Publication
(10) Pub. No.: US 2026/0258638 A1
(43) Pub. Date: Sep. 3, 2026

(54) AUTOMATICALLY ENABLING AND DISABLING AN AUTONOMOUS CONTROL SCHEME FOR AN IMPLEMENT OF A MACHINE

(71) Applicant: Caterpillar Inc., Peoria, IL (US)

(72) Inventors: Bradley Paul KRONE, Dunlap, IL (US); Joseph Leo FAIVRE, Edelstein, IL (US); Jason BRAKER, Speer, IL (US); Kaivalya Vijay KHORGADE, Peoria, IL (US)

(73) Assignee: Caterpillar Inc., Peoria, IL (US)

(21) Appl. No.: 19/067,105

(22) Filed: Feb. 28, 2025

(51) Int. Cl. E02F 9/26; E02F 3/84; E02F 9/20

(52) U.S. Cl. CPC E02F 9/261; E02F 9/2045; E02F 3/841

(57) ABSTRACT

A controller of a machine may obtain multi-dimensional operational context information associated with the machine. The controller may determine, based on the multi-dimensional operational context information, whether a dynamic condition is satisfied. The controller may selectively enable or disable an autonomous control scheme for an implement of the machine based on determining whether the dynamic condition is satisfied.

### TECHNICAL FIELD

The present disclosure relates generally to a machine and, for example, to automatically enabling and disabling an autonomous control scheme for an implement of the machine.

### BACKGROUND

Machines may be used to perform a variety of tasks at a worksite. For example, machines may be used to excavate, move, shape, contour, and/or remove material present at the worksite, such as gravel, concrete, asphalt, soil, and/or other materials. In many cases, autonomous control of a machine's implement can enhance a precision and an efficiency of a work operation of the machine, increasing a likelihood of achieving a desired result of the work operation. For example, when the machine is a dozer with a blade as an implement, autonomous control of the blade enables the machine to grade a work surface to a specified level with greater accuracy and consistency.

While autonomous control of a machine's implement can improve an accuracy and efficiency of work operations, there are instances where autonomous control is not beneficial or even hinders a performance of the machine. For example, when a dozer is traveling between work areas, an actively controlled blade is often inconvenient, unneeded, or can unnecessarily engage with terrain between the work areas. In such situations, the machine should have the ability to automatically disable the autonomous control of the implement (e.g., without input of an explicit disable command by an operator of the machine) to prevent unwanted interference. Further, the machine should have the ability to automatically enable (e.g., re-enable) the autonomous control of the implement (e.g., without input of an explicit enable command by an operator of the machine), such as when the machine enters a new work area, facilitating a transition to execution of the next work operation.

The controller of the present disclosure solves one or more of the problems set forth above and/or other problems in the art.

### SUMMARY

A machine may include an implement, and a controller configured to: obtain multi-dimensional operational context information associated with the machine; determine, based on the multi-dimensional operational context information, whether a dynamic condition for enabling or disabling an autonomous control scheme for the implement is satisfied; and selectively enable or disable the autonomous control scheme based on determining whether the dynamic condition is satisfied.

A controller of a machine may include one or more memories, and one or more processors, coupled to the one or more memories, configured to: obtain multi-dimensional operational context information associated with the machine; determine, based on the multi-dimensional operational context information, whether a dynamic condition is satisfied; and selectively enable or disable an autonomous control scheme for an implement of the machine based on determining whether the dynamic condition is satisfied.

A method may include determining, by a controller of a machine, based on multi-dimensional operational context information associated with the machine, whether a dynamic condition is satisfied; and selectively enabling or disabling, by the controller, an autonomous control scheme for an implement of the machine based on determining whether the dynamic condition is satisfied.

### BRIEF DESCRIPTION OF THE DRAWINGS

FIG. 1 is a side view of an example machine.

FIGS. 2A-2B are diagrams of an example implementation described herein.

FIG. 3 is a diagram of example components of a device associated with automatically enabling and disabling an autonomous control scheme for an implement of a machine.

FIG. 4 is a flowchart of an example process associated with automatically enabling and disabling an autonomous control scheme for an implement of a machine.

### DETAILED DESCRIPTION

This disclosure relates to a controller of a machine that includes an implement and is applicable to any machine that performs an operation, such as a machine that utilizes an autonomous control scheme for the implement. For example, the machine may be any machine that performs an operation associated with an industry such as, for example, mining, construction, farming, transportation, or any other industry. As some examples, the machine may be a dozer, a tractor, a tractor scraper, a backhoe loader, a wheel loader, a harvester, an excavator, a motor grader, a skid steer loader, a cold planer, a compactor, a feller buncher, a forest machine, a forwarder, an industrial loader, a knuckleboom loader, a material handler, a pipelayer, a road reclaimer, a skid steer loader, or other above-ground equipment, or underground equipment.

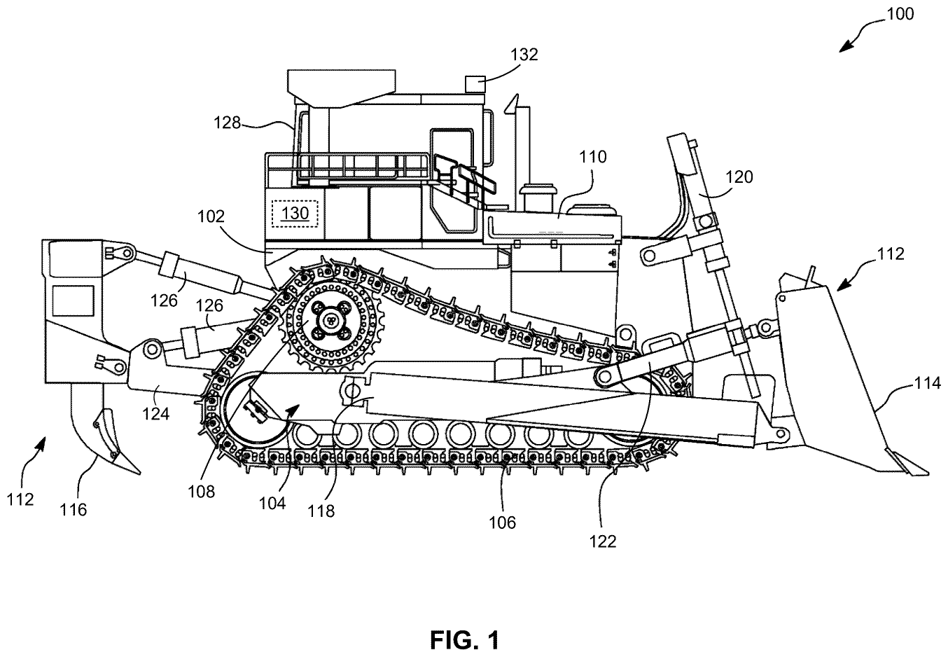

FIG. 1 is a side view of an example machine 100. The machine 100 may perform earth moving, excavation, or another operation associated with an industry such as construction or mining, among other examples. That is, the machine 100 is a work machine. For example, as illustrated in FIG. 1, the machine 100 is a dozer. However, the machine 100 may be another type of machine, as described above.

The machine 100 includes a frame 102 that is supported by an undercarriage 104 used to propel the machine 100. The undercarriage 104 is configured to engage a ground surface, such as a road or another type of terrain. The undercarriage 104 includes a pair of endless tracks 106 (only one endless track 106 is visible in FIG. 1) driven by respective drive wheels 108. Although the machine 100 is illustrated as having tracks 106, the undercarriage 104 may additionally, or alternatively, include one or more wheels for propelling the machine 100.

The frame 102 supports a prime mover 110. The prime mover 110 may include an engine (e.g., an internal combustion engine), such as a diesel engine, a gasoline engine, or a gaseous fuel engine, among other examples, or an electric motor (e.g., for electric powering of machine 100 or hybrid powering of machine 100 with the engine). The prime mover 110 is configured to provide power to drive the tracks 106. Furthermore, the prime mover 110 is configured to provide power to one or more implements 112 (e.g., by driving one or more hydraulic pumps that provide pressurized fluid to one or more actuators of the machine 100).

In FIG. 1, the implements 112 are illustrated as a blade 114, attached to a front of the machine 100, and a ripper 116 attached to a rear of the machine 100. Other embodiments can include any other suitable implement for dozing, brushing, compacting, grading, lifting, loading, plowing, and/or ripping, among other examples. Example implements 112 include a stump grinder, a trencher, a broom, a brush cutter, a cold planer, a moldboard, a hook, a backhoe, a mower, a mulcher, a processor, a pulverizer, a rake, a saw, a snow product, a snow blower, a tiller, a winch, an auger, a bucket, a scoop, a breaker/hammer, a compactor, a cutter, a forked lifting device, a grader bit and end bit, and/or a grapple, among other examples.

The implements 112 are movable with respect to the frame 102. For example, the blade 114 may be pivotally connected to the frame 102 by arms 118 on each side of the machine 100. One or more first hydraulic cylinders 120 may be coupled to the frame 102 to support the blade 114 in the vertical direction and allow the blade 114 to move up or down vertically. Additionally, one or more second hydraulic cylinders 122 may be included on each side of the machine 100 to allow a pitch or an angle of the blade 114 to change. The first and second hydraulic cylinders 120, 122 may be actuators that receive actuation instructions to adjust, lift, lower, or otherwise move and/or position the blade 114. Similarly, the ripper 116 may be pivotally connected to the frame 102 by one or more arms 124, and one or more hydraulic cylinders 126 may be coupled to the frame 102 to support the ripper 116 and allow the ripper 116 to move up or down vertically.

An operator station 128 may be supported on the frame 102 and may include an operator console having one or more displays (e.g., touchscreen displays) and/or one or more operator controls to operate and/or drive the machine 100. For example, the operator controls may include a joystick, a lever, and/or a knob, among other examples. The machine 100 includes a controller 130 for electrically controlling various aspects of the machine 100. For example, the controller 130 (e.g., that includes an electronic control module (ECM) or other computing device) may send and receive signals from various components of the machine 100 during the operation of the machine 100. In some implementations, the controller 130 may be configured to provide autonomous (e.g., fully autonomous or semi-autonomous) control of the machine 100, of one or more functions of the machine 100 (e.g., propulsion, braking, steering, implement movement, or the like), and/or of the one or more implements 112 (e.g., to automatically adjust an implement). For example, the controller 130 may utilize an autonomous control scheme for an implement 112 to enable autonomous control of the implement 112.

One or more sensors 132, configured to mount on machine 100 (e.g., to the frame 102 or the operator station 128), are communicatively coupled to the controller 130 (e.g., by a wired connection or wirelessly). The one or more sensors 132 may include one or more perception sensors, such as a sonar sensor, a camera, a light detection and ranging (LIDAR) sensor, and/or a radio detection and ranging (RADAR) sensor, or another type of sensor to perceive an environment of the machine 100. The one or more sensors 132 may include one or more machine sensors, such as a machine position sensor (e.g., a global positioning system (GPS) sensor, or a local positioning system sensor) configured to determine a location (e.g., a physical location), an orientation, and/or a heading of the machine 100; one or more implement sensors, such as an implement position sensor (e.g., a rotation sensor, or another sensor) configured to determine a location (e.g., a physical location), an orientation, and/or a heading of an implement 112; one or more machine command sensors, such as a command monitoring sensor configured to determine commands (e.g., a machine steering command, an implement movement command) associated with controlling the machine 100 and/or the implement 112 that are input into the operator controls of the operator station 128; one or more machine status sensors, such as a speed sensor configured to determine a speed of the machine 100 (e.g., when travelling over a surface) and/or a steering angle sensor configured to determine a steering angle of the machine 100; and/or one or more other sensors.

As indicated above, FIG. 1 is provided as an example. Other examples may differ from what is described with regard to FIG. 1.

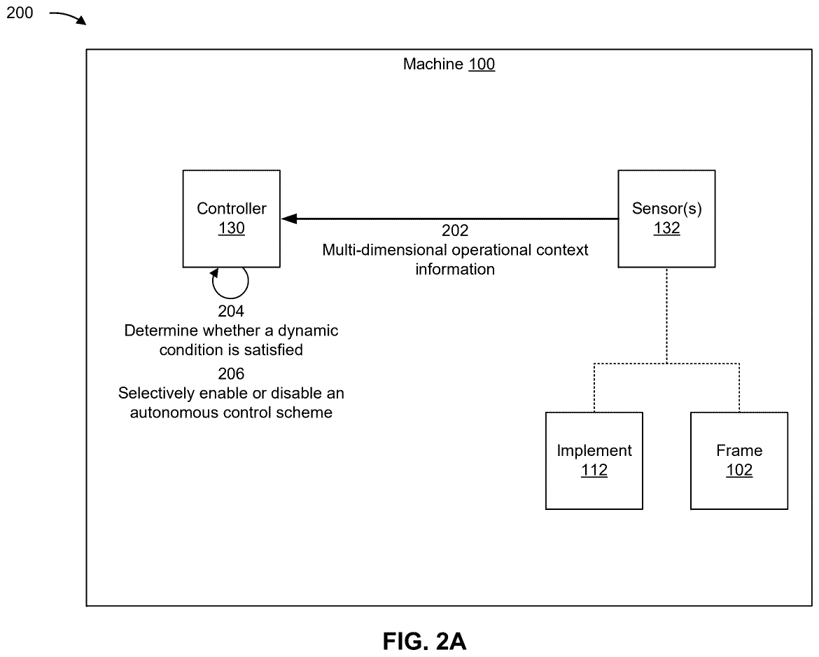

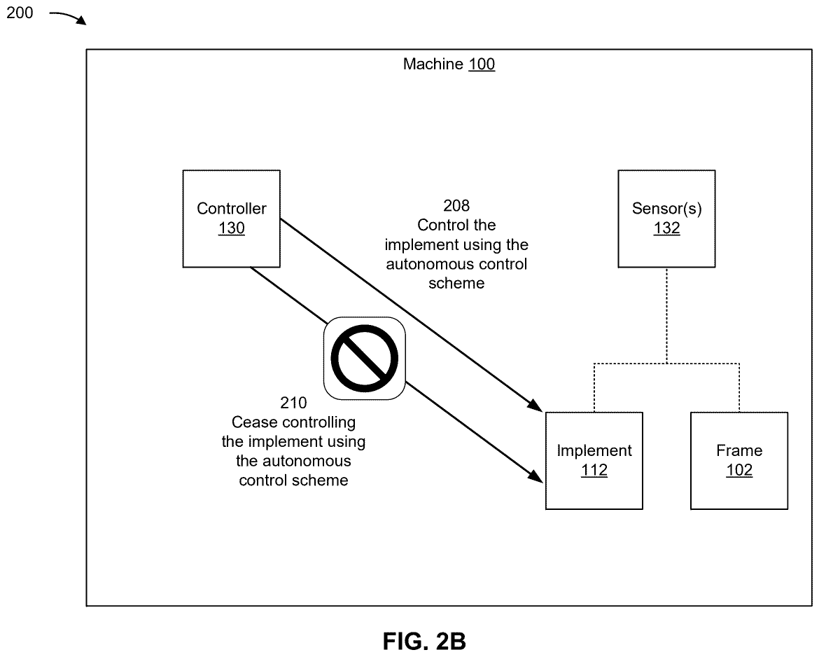

FIGS. 2A-2B are diagrams of an example implementation 200 described herein. FIGS. 2A-2B show how the controller 130 automatically enables or disables an autonomous control scheme for an implement 112 (e.g., a blade 114, a ripper 116, or another type of implement) of the machine 100.

As shown in FIG. 2A, and by reference number 202, the controller 130 obtains multi-dimensional operational context information. For example, the controller 130 may obtain the multi-dimensional operational context information (or at least some of the multi-dimensional operational context information) from the one or more sensors 132, a data storage device included in the machine 100, and/or another component or device of the machine 100. The multi-dimensional operational context information may include respective data captured, stored, or otherwise provided by the one or more sensors 132, the data storage device, and/or the other component or device of the machine 100. In some implementations, the multi-dimensional operational context information (or at least some of the multi-dimensional operational context information) is communicated (e.g., wirelessly communicated) to the controller 130 by another device (e.g., a site monitoring device) or another machine.

The multi-dimensional operational context information may include information respectively associated with a plurality of operational context dimensions, such as with respect to operation of the machine 100 at a site (e.g., a worksite). For example, the multi-dimensional operational context information may include information associated with a first operation context dimension, information associated with a second operation context dimension, and/or so on. In some implementations, the multi-dimensional operational context information may include at least two of implement position information, machine position information, machine command information, machine status information, or terrain information, along with other examples.

The implement position information may indicate, for example, a location, an orientation, and/or a heading of an implement 112 of the machine 100. The machine position information may indicate a location, an orientation, and/or a heading of the machine 100. The machine command information may indicate one or more commands associated with controlling the machine 100 and/or the implement 112 (e.g., that are input into the operator controls of the operator station 128 of the machine 100). The machine status information may indicate one or more status metrics associated with the machine, such as a speed of the machine 100, or a steering angle of the machine 100, along with other examples. The terrain information may indicate, for example, a slope of the site, a topography of the site, a surface composition (e.g., sand, rock, or dirt, along with other examples) of the site, a surface density of the site, a surface roughness of the site, a moisture level of the site, weather conditions associated with the site, and/or locations of obstacles at the site, along with other examples.

As shown by reference number 204, the controller 130 may determine whether a dynamic condition for enabling or disabling an autonomous control scheme for the implement 112 is satisfied (e.g., based on the multi-dimensional operational context information). For example, when the autonomous control scheme is not enabled (e.g., the controller 130 is not controlling the implement 112 using the autonomous control scheme), the controller 130 may determine whether a dynamic condition for enabling the autonomous control scheme is satisfied. As another example, when the autonomous control scheme is enabled (e.g., the controller 130 is actively controlling the implement 112 using the autonomous control scheme), the controller 130 may determine whether a dynamic condition for disabling the autonomous control scheme is satisfied. In some implementations, the dynamic condition can also be referred to as a context-dependent condition, a multi-variable condition, or another type of non-static condition because the dynamic condition is based on an interplay of operational context dimensions of the multi-dimensional operational context information, as further described herein.

In some implementations, the controller 130 may determine, based on the multi-dimensional operational context information, a plurality of parameter values respectively associated with a plurality of operational context dimensions, and may thereby determine, based on the plurality of parameter values, whether the dynamic condition is satisfied. For example, the controller 130 may determine, based on the multi-dimensional operational context information, a first parameter value associated with a first operational context dimension and may determine, based on the multi-dimensional operational context information, a second parameter value associated with a second operational context dimension. The controller 130 may thereby determine, based on the first parameter value and the second parameter value, whether the dynamic condition is satisfied.

In some implementations, the controller 130 may use at least one cost function, or other type of optimization function, to determine whether the dynamic condition is satisfied. That is, the controller 130 may process the multi-dimensional operational context information to determine whether the dynamic condition is satisfied. For example, the controller 130 may process a first parameter value associated with a first operational context dimension, a second parameter value associated with a second operational context dimension, and/or so on, using at least one cost function to determine whether the dynamic condition is satisfied. Accordingly, the controller 130 may determine whether the dynamic condition is satisfied based on a plurality of parameter values respectively associated with a plurality of operational context dimensions indicated by the multi-dimensional operational context information.

In some implementations, to determine whether the dynamic condition is satisfied, the controller 130 may determine whether a parameter value, of the plurality of values, is within a particular range to determine (e.g., in association with evaluating other parameter values of the plurality of values) whether the dynamic condition is satisfied, such as detailed in the following examples. For example, the controller 130 may determine an operational position range for the implement 112 (e.g., that is associated with the autonomous control scheme) and may determine, based on implement position information included in the multi-dimensional operational context information, a dynamic operational position of the implement 112 (e.g., a real-time position of the implement 112). The controller 130 may determine whether the dynamic operational position of the implement 112 is within the operational position range and may thereby determine, based on (e.g., at least partly based on) determining whether the dynamic operational position is within the operational position range, whether the dynamic condition is satisfied. As an example, when the implement 112 is a blade 114, the controller 130 may determine whether a dynamic operational position of the implement 112 is within an operational position range associated with dozing to determine whether the dynamic condition is satisfied. Accordingly, when the autonomous control scheme is not enabled (e.g., the controller 130 is not controlling the implement 112 using the autonomous control scheme), the controller 130 may determine that the dynamic condition is satisfied based on determining that the dynamic operational position of the implement 112 is within the operational position range (which may cause the controller 130 to enable the autonomous control scheme, as further described herein). Alternatively, when the autonomous control scheme is enabled (e.g., the controller 130 is actively controlling the implement 112 using the autonomous control scheme), the controller 130 may determine that the dynamic condition is satisfied based on determining that the dynamic operational position of the implement 112 is not within the operational position range (which may cause the controller 130 to disable the autonomous control scheme, as further described herein).

In another example, the controller 130 may determine an operational position range for the machine 100 (e.g., that is associated with the autonomous control scheme) and may determine, based on machine position information included in the multi-dimensional operational context information, a dynamic operational position of the machine 100 (e.g., a real-time position of the machine 100). The controller 130 may determine whether the dynamic operational position of the machine 100 is within the operational position range and may thereby determine, based on (e.g., at least partly based on) determining whether the dynamic operational position is within the operational position range, whether the dynamic condition is satisfied. As an example, when the machine 100 is a dozer, the controller 130 may determine whether a dynamic pitch of the machine 100 is within an operational position range (e.g., an operational pitch range of the machine 100) to determine whether the dynamic condition is satisfied. Accordingly, when the autonomous control scheme is not enabled (e.g., the controller 130 is not controlling the implement 112 using the autonomous control scheme), the controller 130 may determine that the dynamic condition is satisfied based on determining that the dynamic operational position of the machine 100 is within the operational position range (which may cause the controller 130 to enable the autonomous control scheme, as further described herein). Alternatively, when the autonomous control scheme is enabled (e.g., the controller 130 is actively controlling the implement 112 using the autonomous control scheme), the controller 130 may determine that the dynamic condition is satisfied based on determining that the dynamic operational position of the machine 100 is not within the operational position range (which may cause the controller 130 to disable the autonomous control scheme, as further described herein).

In an additional example, the controller 130 may determine an operational command range for the machine 100 (e.g., that is associated with the autonomous control scheme) and may determine, based on machine command information included in the multi-dimensional operational context information, a dynamic operational command of the machine 100 (e.g., a real-time command of the machine 100 that is input via the one or more operator controls of the operator station 128 of the machine 100). The controller 130 may determine whether the dynamic operational command is within the operational command range and may thereby determine, based on (e.g., at least partly based on) determining whether the dynamic operational command is within the operational command range, whether the dynamic condition is satisfied. As an example, when the machine 100 is a dozer, the controller 130 may determine whether a steering command (e.g., in terms of degrees, degrees per second, or another metric) of the machine 100 is within an operational steering range (e.g., a steering range for performing a dozing operation) to determine whether the dynamic condition is satisfied. Accordingly, when the autonomous control scheme is not enabled (e.g., the controller 130 is not controlling the implement 112 using the autonomous control scheme), the controller 130 may determine that the dynamic condition is satisfied based on determining that the dynamic operational command is within the operational command range (which may cause the controller 130 to enable the autonomous control scheme, as further described herein). Alternatively, when the autonomous control scheme is enabled (e.g., the controller 130 is actively controlling the implement 112 using the autonomous control scheme), the controller 130 may determine that the dynamic condition is satisfied based on determining that the dynamic operational command is not within the operational command range (which may cause the controller 130 to disable the autonomous control scheme, as further described herein).

In another example, the controller 130 may determine an operational status range for the machine 100 (e.g., that is associated with the autonomous control scheme) and may determine, based on machine status information included in the multi-dimensional operational context information, a dynamic status of the machine 100 (e.g., a real-time status of the machine 100). The controller 130 may determine whether the dynamic status is within the operational status range and may thereby determine, based on (e.g., at least partly based on) determining whether the dynamic status is within the operational status range, whether the dynamic condition is satisfied. As an example, when the machine 100 is a dozer, the controller 130 may determine whether a speed of the machine 100 is within an operational speed range (e.g., a speed range for performing a dozing operation) to determine whether the dynamic condition is satisfied. Accordingly, when the autonomous control scheme is not enabled (e.g., the controller 130 is not controlling the implement 112 using the autonomous control scheme), the controller 130 may determine that the dynamic condition is satisfied based on determining that the dynamic status is within the operational status range (which may cause the controller 130 to enable the autonomous control scheme, as further described herein). Alternatively, when the autonomous control scheme is enabled (e.g., the controller 130 is actively controlling the implement 112 using the autonomous control scheme), the controller 130 may determine that the dynamic condition is satisfied based on determining that the dynamic status is not within the operational status range (which may cause the controller 130 to disable the autonomous control scheme, as further described herein).

In a further example, the controller 130 may determine an operational position range for the machine 100 (e.g., that is associated with the autonomous control scheme) and may determine, based on terrain information included in the multi-dimensional operational context information, a predicted operational position of the machine 100 (e.g., a position of the machine 100 along a projected path of the machine 100). The controller 130 may determine whether the predicted operational position of the machine 100 is within the operational position range and may thereby determine, based on (e.g., at least partly based on) determining whether the predicted operational position is within the operational position range, whether the dynamic condition is satisfied. As an example, when the machine 100 is a dozer, the controller 130 may determine whether a predicted location of the machine 100 is within an operational position range (e.g., within a bounds of a work site) to determine whether the dynamic condition is satisfied. Accordingly, when the autonomous control scheme is not enabled (e.g., the controller 130 is not controlling the implement 112 using the autonomous control scheme), the controller 130 may determine that the dynamic condition is satisfied based on determining that the predicted operational position of the machine 100 is within the operational position range (which may cause the controller 130 to enable the autonomous control scheme, as further described herein). Alternatively, when the autonomous control scheme is enabled (e.g., the controller 130 is actively controlling the implement 112 using the autonomous control scheme), the controller 130 may determine that the dynamic condition is satisfied based on determining that the predicted operational position of the machine 100 is not within the operational position range (which may cause the controller 130 to disable the autonomous control scheme, as further described herein).

As shown by reference number 206, the controller 130 may selectively enable or disable the autonomous control scheme (e.g., based on determining whether the dynamic condition is satisfied). As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

Accordingly, selectively enabling or disabling the autonomous control scheme may include enabling the autonomous control scheme. For example, when the autonomous control scheme is not enabled (e.g., the controller 130 is not controlling the implement 112 using the autonomous control scheme), the controller 130 may enable the autonomous scheme (e.g., based on determining that the dynamic condition is satisfied). Additionally, selectively enabling or disabling the autonomous control scheme may include disabling the autonomous control scheme. For example, when the autonomous control scheme is enabled (e.g., the controller 130 is actively controlling the implement 112 using the autonomous control scheme), the controller 130 may disable the autonomous scheme (e.g., based on determining that the dynamic condition is satisfied). In this way, the controller 130 may be configured to enable the autonomous control scheme when the autonomous control scheme is disabled (e.g., based on determining that the dynamic condition is satisfied), and to disable the autonomous control scheme when the autonomous control scheme is enabled (e.g., based on determining that the dynamic condition is satisfied).

As shown in FIG. 2B, and by reference number 208, the controller 130 may control the implement 112 using the autonomous control scheme. For example, the controller 130 may control the implement 112 using the autonomous control scheme based on enabling the autonomous control scheme (e.g., as described herein in relation to FIG. 2A and reference number 206). Accordingly, the controller 130 may adjust the implement 112 to control the implement 112 using the autonomous control scheme. For example, the controller 130, using the autonomous control scheme, may generate and send one or more control instructions to one or more components of the machine 100, such as the one or more first hydraulic cylinders 120 and/or the one or more second hydraulic cylinders 122, to adjust, lift, lower, or otherwise move and/or position the implement.

As shown by reference number 210, the controller 130 may cease controlling the implement 112 using the autonomous control scheme. For example, the controller 130 may cease controlling the implement 112 using the autonomous control scheme based on disabling the autonomous control scheme (e.g., as described herein in relation to FIG. 2A and reference number 206). Accordingly, the controller 130 may cease adjusting the implement 112.

The controller 130 may repeatedly perform one or more operations described herein in relation to FIGS. 2A-2B, such as at a subsequent time. For example, after enabling the autonomous control scheme (and thereby controlling the implement 112 using the autonomous control scheme), the controller 130 may obtain other multi-dimensional operational context information associated with the machine 100 and thereby determine (e.g., based on the other multi-dimensional operational context information) that another dynamic condition for disabling the autonomous control scheme for the implement is satisfied. Accordingly, the controller 130 may disable the autonomous control scheme based on determining that the other dynamic condition is satisfied. As another example, after disabling the autonomous control scheme (and thereby ceasing control of the implement 112 using the autonomous control scheme), the controller 130 may obtain other multi-dimensional operational context information associated with the machine 100 and thereby determine (e.g., based on the other multi-dimensional operational context information) that another dynamic condition for disabling the autonomous control scheme for the implement is satisfied. Accordingly, the controller 130 may enable the autonomous control scheme based on determining that the other dynamic condition is satisfied. In this way, the controller 130, at a first time, may enable the autonomous control scheme when the autonomous control scheme is disabled (e.g., based on determining that a first dynamic condition is satisfied), and, at a second time (e.g., that occurs before or after the first time), may disable the autonomous control scheme when the autonomous control scheme is enabled (e.g., based on determining that a second dynamic condition is satisfied).

As indicated above, FIGS. 2A-2B are provided as an example. Other examples may differ from what is described in connection with FIGS. 2A-2B.

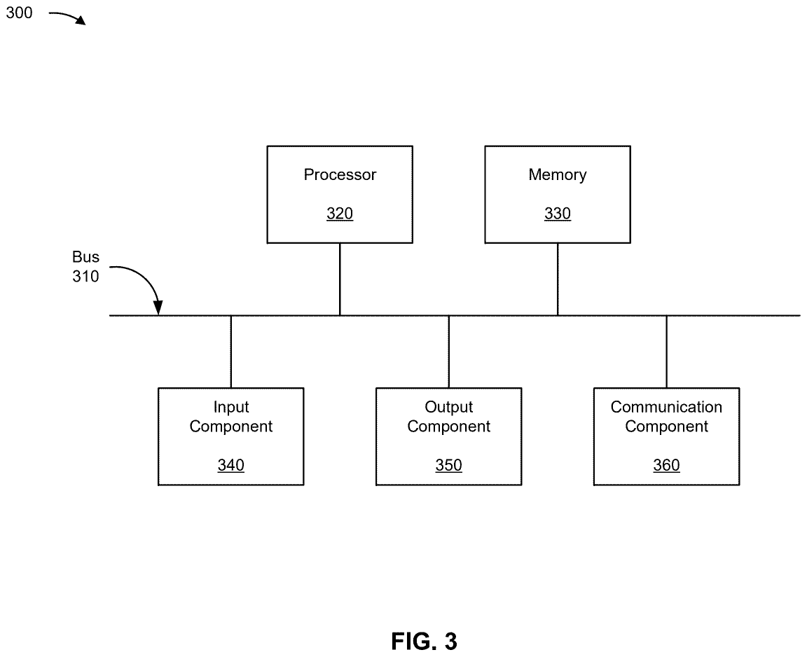

FIG. 3 is a diagram of example components of a device 300 associated with automatically enabling and disabling an autonomous control scheme for an implement of a machine. The device 300 corresponds to the controller 130, the one or more sensors 132, and/or one or more other components of the machine 100. In some implementations, the controller 130, the one or more sensors 132, and/or one or more other components of the machine 100 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. A set of components (e.g., one or more components) of the device 300 may perform one or more functions described as being performed by another set of components of the device 300.

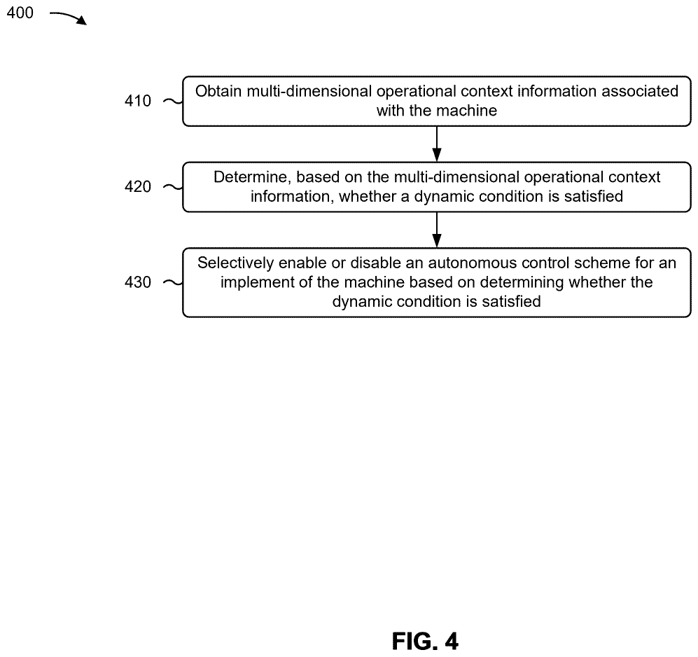

FIG. 4 is a flowchart of an example process 400 associated with automatically enabling and disabling an autonomous control scheme for an implement of a machine. One or more process blocks of FIG. 4 may be performed by a controller (e.g., the controller 130) or a machine (e.g., the machine 100). Additionally, or alternatively, one or more process blocks of FIG. 4 may be performed by another device or a group of devices separate from or including the controller, such as another device or component that is internal or external to the machine.

As shown in FIG. 4, process 400 may include obtaining multi-dimensional operational context information associated with the machine (block 410). For example, the controller may obtain multi-dimensional operational context information associated with the machine, as described above. The multi-dimensional operational context information may include at least two of implementing position information, machine position information, machine command information, machine status information, or terrain information.

As further shown in FIG. 4, process 400 may include determining, based on the multi-dimensional operational context information, whether a dynamic condition is satisfied (block 420). For example, the controller may determine, based on the multi-dimensional operational context information, whether a dynamic condition (e.g., for enabling or disabling an autonomous control scheme for an implement of the machine) is satisfied, as described above.

As further shown in FIG. 4, process 400 may include selectively enabling or disabling an autonomous control scheme for an implement of the machine based on determining whether the dynamic condition is satisfied (block 430). For example, the controller may selectively enable or disable an autonomous control scheme for an implement of the machine based on determining whether the dynamic condition is satisfied, as described above.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

Implementations described herein may be used with any machine that includes a controller and an implement, such as a dozer that includes a controller and a blade. The machine may be any machine that performs an operation associated with an industry such as, for example, mining, construction, farming, transportation, or any other industry.

An autonomous control scheme may be used (e.g., by the controller) to control the implement, such as to enhance a precision and efficiency of a work operation of the machine. However, there are times when autonomous control of the implement is not beneficial or even hinders a performance of the machine. For example, when a dozer is traveling between work areas, an actively controlled blade is often inconvenient, unneeded, or can unnecessarily engage with terrain between the work areas. Consequently, the machine wastes time and resources to perform an unnecessary work operation, which decreases a productivity of the machine.

Some implementations described herein include a controller of a machine that automatically enables and disables an autonomous control scheme for an implement of the machine. For example, the controller obtains multi-dimensional operational context information associated with the machine and thereby determines whether a dynamic condition for enabling or disabling the autonomous control scheme for the implement is satisfied. The controller may determine whether the dynamic condition is satisfied, for example, based on a plurality of parameter values (e.g., that are respectively associated with a plurality of operational context dimensions) that the controller determines based on processing the multi-dimensional operational context information.

The controller then selectively enables or disables the autonomous control scheme based on determining whether the dynamic condition is satisfied. For example, when the autonomous control scheme is not enabled (e.g., the controller is not controlling the implement using the autonomous control scheme), the controller may enable the autonomous scheme (e.g., based on determining that the dynamic condition is satisfied). As another example, when the autonomous control scheme is enabled (e.g., the controller is actively controlling the implement using the autonomous control scheme), the controller may disable the autonomous scheme (e.g., based on determining that the dynamic condition is satisfied).

In this way, the controller is configured to enable the autonomous control scheme when the autonomous control scheme is disabled (e.g., based on determining that the dynamic condition is satisfied), and to disable the autonomous control scheme when the autonomous control scheme is enabled (e.g., based on determining that the dynamic condition is satisfied). Thus, the controller automatically disables the autonomous control scheme (e.g., without input of an explicit disable command by an operator of the machine), which prevents unwanted interference of a non-work operation of the machine by the implement. For example, when the machine is a dozer and is traveling between work areas, the controller disables the autonomous control scheme, which prevents a blade of the machine unnecessarily engaging with terrain between the work areas. Consequently, the controller avoids performance of an unnecessary work operation, which minimizes wasted time and resources and therefore increases a productivity of the machine. Further, the controller automatically enables (e.g., re-enables) the autonomous control scheme (e.g., without input of an explicit enable command by an operator of the machine), which facilitates a transition to execution of a next work operation of the machine.

What is claimed is:

1. A machine, comprising:
an implement; and
a controller configured to:
obtain multi-dimensional operational context information associated with the machine;
determine, based on the multi-dimensional operational context information, whether a dynamic condition for enabling or disabling an autonomous control scheme for the implement is satisfied; and
selectively enable or disable the autonomous control scheme based on determining whether the dynamic condition is satisfied.

2. The machine of claim 1, wherein the multi-dimensional operational context information includes at least two of:
implement position information,
machine position information,
machine command information,
machine status information, or
terrain information.

3. The machine of claim 1, wherein the controller, to determine whether the dynamic condition is satisfied, is configured to:
determine an operational position range for the implement that is associated with the autonomous control scheme;
determine, based on implement position information included in the multi-dimensional operational context information, a dynamic operational position of the implement;
determine whether the dynamic operational position is within the operational position range; and
determine, based on determining whether the dynamic operational position is within the operational position range, whether the dynamic condition is satisfied.

4. The machine of claim 1, wherein the controller, to determine whether the dynamic condition is satisfied, is configured to:
determine an operational position range for the machine that is associated with the autonomous control scheme;
determine, based on machine position information included in the multi-dimensional operational context information, a dynamic operational position of the machine;
determine whether the dynamic operational position is within the operational position range; and
determine, based on determining whether the dynamic operational position is within the operational position range, whether the dynamic condition is satisfied.

5. The machine of claim 1, wherein the controller, to determine whether the dynamic condition is satisfied, is configured to:
determine an operational command range for the machine that is associated with the autonomous control scheme;
determine, based on machine command information included in the multi-dimensional operational context information, a dynamic operational command of the machine;
determine whether the dynamic operational command is within the operational command range; and
determine, based on determining whether the dynamic operational command is within the operational command range, whether the dynamic condition is satisfied.

6. The machine of claim 1, wherein the controller, to determine whether the dynamic condition is satisfied, is configured to:
determine an operational status range for the machine that is associated with the autonomous control scheme;
determine, based on machine status information included in the multi-dimensional operational context information, a dynamic status of the machine;
determine whether the dynamic status is within the operational status range; and
determine, based on determining whether the dynamic status is within the operational status range, whether the dynamic condition is satisfied.

7. The machine of claim 1, wherein the controller, to determine whether the dynamic condition is satisfied, is configured to:
determine an operational position range for the machine that is associated with the autonomous control scheme;
determine, based on terrain information included in the multi-dimensional operational context information, a predicted operational position of the machine;
determine whether the predicted operational position is within the operational position range; and
determine, based on determining whether the predicted operational position is within the operational position range, whether the dynamic condition is satisfied.

8. The machine of claim 1, wherein the controller, to determine whether the dynamic condition is satisfied, is configured to:
determine, based on the multi-dimensional operational context information, a first parameter value associated with a first operational context dimension;
determine, based on the multi-dimensional operational context information, a second parameter value associated with a second operational context dimension; and
determine, based on the first parameter value and the second parameter value, whether the dynamic condition is satisfied.

9. The machine of claim 1, wherein the controller, to determine whether the dynamic condition is satisfied, is configured to:
process, using at least one cost function, the multi-dimensional operational context information to determine whether the dynamic condition is satisfied.

10. The machine of claim 1, wherein the controller is further configured to:
obtain, after enabling the autonomous control scheme, other multi-dimensional operational context information associated with the machine;
determine, based on the other multi-dimensional operational context information, that another dynamic condition for disabling the autonomous control scheme for the implement is satisfied; and
disable the autonomous control scheme based on determining that the other dynamic condition is satisfied.

11. The machine of claim 1, wherein the controller is further configured to:
obtain, after disabling the autonomous control scheme, other multi-dimensional operational context information associated with the machine;
determine, based on the other multi-dimensional operational context information, that another dynamic condition for enabling the autonomous control scheme for the implement is satisfied; and
enable the autonomous control scheme based on determining that the other dynamic condition is satisfied.

12. A controller of a machine, comprising:
one or more memories; and
one or more processors, coupled to the one or more memories, configured to:
obtain multi-dimensional operational context information associated with the machine;
determine, based on the multi-dimensional operational context information, whether a dynamic condition is satisfied; and
selectively enable or disable an autonomous control scheme for an implement of the machine based on determining whether the dynamic condition is satisfied.

13. The controller of claim 12, wherein the multi-dimensional operational context information includes at least two of:
implement position information,
machine position information,
machine command information,
machine status information, or
terrain information.

14. The controller of claim 12, wherein one or more processors, to determine whether the dynamic condition is satisfied, are configured to:
determine, based on the multi-dimensional operational context information, a first parameter value associated with a first operational context dimension and a second parameter value associated with a second operational context dimension; and
determine, based on the first parameter value and the second parameter value, whether the dynamic condition is satisfied.

15. The controller of claim 12, wherein one or more processors, to determine whether the dynamic condition is satisfied, are configured to:
process, using at least one cost function, the multi-dimensional operational context information to determine whether the dynamic condition is satisfied.

16. The controller of claim 12, wherein one or more processors are further configured to:
obtain, after enabling the autonomous control scheme, other multi-dimensional operational context information associated with the machine;
determine, based on the other multi-dimensional operational context information, that another dynamic condition for disabling the autonomous control scheme for the implement is satisfied; and
disable the autonomous control scheme based on determining that the dynamic condition is satisfied.

17. The controller of claim 12, wherein one or more processors are further configured to:
obtain, after disabling the autonomous control scheme, other multi-dimensional operational context information associated with the machine;
determine, based on the other multi-dimensional operational context information, that another dynamic condition for enabling the autonomous control scheme for the implement is satisfied; and
enable the autonomous control scheme based on determining that the other dynamic condition is satisfied.

18. A method, comprising:
determining, by a controller of a machine, based on multi-dimensional operational context information associated with the machine, whether a dynamic condition is satisfied; and
selectively enabling or disabling, by the controller, an autonomous control scheme for an implement of the machine based on determining whether the dynamic condition is satisfied.

19. The method of claim 18, wherein determining whether the dynamic condition is satisfied comprises:
determining, based on the multi-dimensional operational context information, a plurality of parameter values respectively associated with a plurality of operational context dimensions; and
determining, based on the plurality of parameter values, whether the dynamic condition is satisfied.

20. The method of claim 18, further comprising:
controlling, after enabling the autonomous control scheme, the implement using the autonomous control scheme.
